(19) United States
(12) Patent Application Publication
(10) Pub. No.: US 2014/0164264 A1
(43) Pub. Date: Jun. 12, 2014

(54) SYSTEM AND METHOD FOR IDENTIFYING AND LEARNING ACTIONABLE OPPORTUNITIES ENABLED BY TECHNOLOGY FOR URBAN SERVICES

(71) Applicant: CityScan, Inc., Chicago, IL (US)

(72) Inventors: David Guttman, Chicago, IL (US); Orlando Saez, Geneva, IL (US)

(73) Assignee: CityScan, Inc., Chicago, IL (US)

(21) Appl. No.: 14/178,250

(22) Filed: Feb. 11, 2014

Related U.S. Application Data
(60) Provisional application No. 61/634,468, filed on Feb. 29, 2012.

(51) Int. Cl. G06Q 50/16; G06F 17/50; G06Q 30/00

(52) U.S. Cl. CPC G06Q 50/16; G06Q 30/018; G06F 17/5009
USPC 705/313; 703/1

(57) ABSTRACT

The present disclosure provides systems and methods of identifying actionable location-specific opportunities using the steps of: receiving a three-dimensional dataset forming a model of an urban landscape; analyzing other third-party private and/or public dataset and including elements of municipal records and rules to identify location-specific matches; and using heuristic algorithms to evaluate the location-specific matches to create a data compilation that identifies one or more actionable location-specific opportunities.

### CROSS-REFERENCE TO RELATED APPLICATIONS

This application incorporates by reference and claims priority to U.S. Provisional Application 61/634,468 filed on Feb. 11, 2013.

### BACKGROUND OF THE INVENTION

The present subject matter relates generally to systems and methods for identifying, learning, and integrating actionable knowledge and location specific opportunities driven to improve safety, quality of life, and increase municipal revenue by providing cost recovery opportunities.

Mobile mapping infrastructure and its' associated technology can play a key role in improving life safety and community sustainability in an urban environment. Used well, such infrastructure and technology can provide a positive economic impact in the communities in which it is employed. A complex challenge facing urban planners is trying to effectively link a plethora of digital geo-spatial reference models to changes in the built environment and to citizen activity.

Across the nation, many municipalities are facing budget concerns. One opportunity for municipalities to generate revenue by identifying cost recovery opportunities is to be more efficient at identifying and enforcing existing regulation violations. Comprehensive municipal code enforcement can lead to proper revenue generation and help to streamline data-driven policy.

Municipalities throughout the United States collect revenue from permits and licenses for various operations within their cities. For examples, municipalities require permits and licenses for the operation of billboards, signs, building codes, zoning rules, public way, inspections, etc. With respect to understaffed departments and inadequate resources, municipalities nationwide have been unable to adequately monitor the asset inventories for a variety of assets classes in their jurisdictions including but not limited to billboards, on premise signs, valet spots, loading zones, construction activity, and many more. License and permitting fees have not been collected in a timely manner, if they have been collected at all. In addition, regulations around these assets classes often go unenforced and the corresponding fines have been rarely collected.

As noted, because of the expense and complexity of maintaining asset databases manually, municipalities have fallen behind in asset enforcement in the current financial downturn. Large cities are unable to answer even the most basic questions about the assets within their jurisdiction. For example, municipalities commonly do not know how many assets were erected in the last year, what percentage of those erected have proper permits, how often do inspections occur, and at what cost. Further, municipalities commonly do not have reliable data related to the proportion of assets that were inspected over the last year, how licensing policies are enforced, the amount of revenue that is lost from uncollected licensing fees and illegally placed signs. For billboards alone, it is estimated that about 25% go without inspection, do not pay licensing fees, or are illegally placed. Every year municipal fees go uncollected on about 150,000 billboards nationally, and cities are failing to collect over $50 million per year of revenue. This problem exists not just for billboards but also for other classes of infrastructure assets such as on-premise signs, construction fixtures and more.

Cities adapt regulations in an attempt to achieve a balance between outdoor billboard operators and standards to prevent distraction, clutter and blight. Even when regulations exist, violations cause public safety issues. Cities are faced with serious decisions regarding enforcement due to limited resources. Further, the current methods employed by governments to inventory assets in their jurisdiction for their municipal permitting, enforcement, and planning efforts are expensive and inefficient. The falling cost of data acquisition imaging systems, along with the increased accuracy of emerging geo-spatial technologies, make it possible for data collection efforts to move away from impractical and labor-intensive manual surveys into comprehensive, and fact-based, automated imaging systems that are able to deliver accurate and more up-to-date outdoor inventories.

However, even as data acquisition systems and imaging systems proliferate, significant complexity remains in object extraction and correlation of extracted objects in the physical space with existing municipal records, zoning rules and licensing codes. A primary complexity is that these data sets normally use different methods to identify a specific location, not to mention the location, size, and other characteristics in the built environment. As described below, the proposed systems and methods address the framework and processes needed to greatly reduce a labor-intensive.

There are many ways of describing a physical location on Planet Earth. Datasets published by different departments in different municipalities could describe the location of an element of the built environment by using latitude/longitude, X/Y coordinates of a localized projected coordinate system, an address or range of addresses in a variety of formats, parcel ID, street intersection, non-addressable place name, or something else entirely. Geospatial data must be verified, addresses must be cleaned, normalized, and geocoded, and everything must be linked together. Linking the data together, in addition to being useful, is necessary in the case of “one-to-many” problems. For example, one sign structure may host multiple on-premise signs, which may have different owners or be subject to different.

More than just municipalities may benefit by improved systems and methods for identifying location-specific actionable opportunities. Currently, out-of-home media marketing intelligence: (1) relies on models and sporadic route surveys that are impossible to scale; (2) is highly fragmented; and (3) does not take into account emerging outdoor formats. As a result, the value placed on such media is driven by antiquated cost-per-view modeling formulas and aggregated by a few large national operators.

According to the Outdoor Advertising Association of America, the out-of-home (OOH) media industry is worth $6.4 billion per year and is growing at eight percent annually. Despite its size, the current out-of-home marketing intelligence and measurement models rely heavily on sample surveys and visibility simulations, which are inaccurate and predictive. Out-of-home marketing media buying is driven by market intelligence with a vertically integrated supply chain. Mostly “expert” media planners drive brand planning and spending decisions without a real understanding of national network visibility, while largely excluding new digital signage trends. The out-of-home media industry is driven by sales channel strength, not market demand, with large disparities in billboard pricing resulting from the lack of transparency. As online advertising models continue to evolve quickly, brands demand greater understanding of the advertising value delivered by billboards and the audience they reach. It is not surprising that proponents of OOH tout a $4 CPM rates as the lowest among other mass media classes while failing to recognize that this proportionally low cost can be mainly attributed to the lack of real value delivered.

As such, brands and billboard operators need a comprehensive set of visualization, indexing, scoring, and analytics tools to help improve their decision-making process and make smart buying decisions based on individual billboards' actual demographic reach and frequency, allowing scalable outdoor direct response campaigns, while provide quick proof of performance for billboard operators.

In another example, New York City has operated the Street Conditions Observation Unit (“SCOUT”) for several years. SCOUT is a team of inspectors with the mission to drive every city street once per month and report conditions that negatively impact quality of life to the city's non-emergency services department (“311”). Inspectors send reports of conditions they observe to 311, and 311 assigns the conditions to the relevant agency for appropriate corrective action—the very same way that 311 handles complaints from the public.

While the SCOUT program is useful, it fails to provide outdoor knowledge with accurate measurements that can effectively improve the observation on dozens of object classes that can help improve the street level quality of life in city neighborhoods, while enhancing the responsiveness of city government to quality of life conditions.

In yet another example, Traffic and Transportation agencies around the United States are working to comply with the new Federal Highway Administration (FHWA) retro-reflectivity mandates. The FHWA has established a timeline for agencies to become fully compliant with the new minimum retro-reflectivity requirements for traffic signs. Prior to the present invention, municipalities needed to engage costly assessment tools and personnel to determine the reflectivity of each sign and then manually compare the street inventory data with municipal records.

Positioning technologies such as GPS have transformed the manner in which we manage and analyze our world. Modern positioning technologies allow accurate data to be collected from mobile systems; thus, spatial data can be acquired for larger areas faster and more frequently. Until now, capturing data for large areas approaching the size of modern cities was prohibitively expensive. Taking advantage of these positioning technologies in the inventive systems and methods provided herein leads to improved efficiencies in data collection and use.

Accordingly, it may be very valuable to provide a system that can automate the asset extraction and provide strict quality control protocols to ensure the quick assessment and retro-reflectivity of each ground-mounted and overhead guide road sign, among other commercial features, at a fraction of the cost compared to current systems.

Just as current systems are inefficient at identifying location-specific out-of-home marketing opportunities, the current systems are also inefficient at identifying actionable opportunities to improve public safety, quality of life, etc.

As shown by each of the following examples, there is a need for systems and methods for identifying location-specific actionable opportunities, as described and claimed herein.

### BRIEF SUMMARY OF THE INVENTION

To meet the needs described above and others, the present disclosure provides systems and methods in which municipal records are analyzed in combination with three-dimensional (3D) datasets using contextual heuristics to identify actionable revenue generating opportunities for municipalities. In addition, the systems and methods provided herein may be adapted to analyze municipal records in combination with three-dimensional datasets using contextual heuristics to identify location-specific opportunities to improve safety, quality of life, and other factors. The subject matter presented herein provides an effective method to consistently describe and link disparate references primarily based on man-made infrastructure such as buildings, roads, bridges, tunnels, and parks as data containers.

One of the examples used throughout this disclosure relates to out-of-home media (i.e., billboards and other signage). However, it is understood that the primary example is simply one of many examples that may be implemented and is used because it may be particularly well adapted for describing the systems and methods provided herein.

The principal subject matter is to define and measure relevant interactions between digital (i.e. how assets are represented in some digital form) and physical space (i.e. actual observation of street-level conditions) in a city using man-made infrastructure such as buildings, roads, bridges, tunnels, and parks as containers of data. In one example, the present subject matter provides systems and methods in which municipal records are analyzed in combination with three-dimensional geo-spatial datasets, government data, and code enforcement rules using contextual heuristics to identify actionable revenue generating opportunities for municipalities. For example, the system may extract actual outdoor conditions that may be used to compare with municipal records to establish modeling heuristics to predict future likely conditions. In another example, the systems and methods provided herein may be adapted to extract data related to physical space, infrastructure sensor information, temporal knowledge, social media APIs, such as Twitter®, in combination with three-dimensional datasets, and by using contextual heuristics the system may identify location-specific opportunities to improve safety and/or quality of life factors.

Mobile Terrestrial Light Detection and Ranging (LiDAR) is a relatively new system of integrated technologies that provides accurate, high-resolution position and depth information from a laser scanner mounted on a vehicle. This emerging technology generates detailed 3D datasets allowing the mapping and modeling of urban landscapes. This technology meets or exceeds survey-grade accuracy standards (i.e., around 2.5 cm) while providing unprecedented mapping of corridor infrastructure.

The key advantages of Mobile Terrestrial LiDAR (MTL) are: (1) accurate positional data with unprecedented detail can be collected over a wide area; (2) collection does not require the closure of transportation corridors during data acquisition; and (3) it takes radically less time to collect data than it did with previous methods. The present system incorporates MTL, Differential GPS (DGPS), Inertial Measurement Units (IMU) and other imaging technologies to streamline applications that would otherwise require significant labor. The solutions provided enable instant access for immediate business decision intelligence.

The use of MTL coupled with other geo-spatial technologies is fundamentally mobile and allows for a within-scene view. In other words, in a dense urban environment, MTL effectively maps a cylindrical, eye-level swath through the city, as opposed to the previous birds-eye view from a distance (i.e., elevated up to about 1,500 meters). Typically, the goals of MTL within an urban setting are to quickly map urban features such as buildings, billboards and other fixtures. Such maps allow the detection of change within these features over time. An in-vehicle system collects video images, LiDAR point clouds, and other geo-spatial data from a vehicle driving at regular speed down the road. The process of moving from an unorganized point cloud to usable geographic information is technically non-trivial.

Identifying and extracting features at the necessary level of detail is tool-dependent and requires the use of a number of different software applications throughout the feature extraction workflow. Systems on the market today are unable to accurately, effectively, and quickly extract features such as signage or other valuable media assets. The solutions provided herein (made possible by the breakthrough workflow described herein) are combined with complex data analysis to deliver high value, instant, and easy to use outdoor intelligence. The solutions enable customers to broadly access a comprehensive set of geographic web services and self-service tools for the discovery, application, and integration of data for enterprise and consumer applications.

The present systems and methods give municipalities a solution that enables them to generate millions of dollars every year by simply enforcing their current municipal codes that until now they simply didn't have the manpower to enforce.

The systems and methods provide an affordable, intuitive and easy-to-implement solution for several segments of the outdoor advertising industry involved in the planning, monitoring, and maintaining of off-premise and on-premise signage. In addition, the data generated through municipal enforcement may also be used to generate data applicable across several other industries. Accordingly, while many of the examples provided herein are explained with reference to outdoor signage, it is known that the systems and methods may apply to any number of outdoor intelligence contexts.

In one example, the data compilation may be used in code enforcement. For example, the data compilation may feature a map, or a list view, of a particular geography highlighting economic indicators and, in particular, the opportunity cost related to comprehensive code enforcement by comparing city records versus actual street-level data. In one contemplated embodiment, the economic indicators are based on a total direct economic opportunity cost based on new revenue related to licensing plus direct cost savings to municipalities of comprehensive code enforcement plus indirect cost savings on other benefits from crosswalk opportunities with other data sets. Additional potential datasets include building violations, commercial licensing, permits, and others.

In another example of the presently disclosed subject matter, the systems and methods may be used to provide a visual map, graph, list, or other data compilation that includes life safety indicators related to specific geographical locations. For example, applying heuristic models adapted for predictive probability of life safety concerns to the data set collected in the process described above, a data compilation may be provided that identifies locations for likelihood of life safety related incidences. For example, the dataset collected through the use of MTL coupled with other geo-spatial technologies may be evaluated using heuristics adapted to identify high-risk areas for fire. In other examples, the dataset collected through the use of MTL coupled with other geo-spatial technologies may be evaluated using heuristics adapted to identify high-risk areas for illegal activity. It is contemplated that the heuristics used to interpret the dataset may be based, at least in part, on factors such as: arrears on property taxes, liens; building code violations or reported complaints; exterior construction; age of the property; foreclosure history; etc. In a specific example, an algorithm based on the combination of exterior construction and age of the property may be used to evaluate the potential risk of fire for the building.

In an embodiment the method of identifying actionable location-specific opportunities includes receiving a three-dimensional dataset forming a model of an urban landscape, and analyzing the three-dimensional dataset, extracting objects with reference to municipal records to identify location-specific matches between the three-dimensional dataset and elements of the municipal records. In addition, the method includes using heuristic algorithms to evaluate the location-specific matches to create a data compilation that identifies actionable location-specific opportunities.

In an example, the elements of the municipal records used to analyze the three-dimensional dataset may include building code violations. Alternatively, or in addition to, the elements of the municipal records used to analyze the three-dimensional dataset may include commercial licensing. Similarly, the elements of the municipal records used to analyze the three-dimensional dataset may include at least one of permits, arrears on taxes, liens, foreclosure history, or combinations thereof.

In another example, the data compilation is a map including visual indications of actionable location-specific opportunities. Alternatively, or in addition to, the data compilation may be a list including visual indications of actionable location-specific opportunities.

In an example, the actionable location-specific opportunities are economic opportunities. The economic opportunities may be based on a total direct economic opportunity cost measurement based on new revenue, new revenue plus direct cost savings, and/or new revenue plus direct cost savings and indirect cost savings. The actionable location-specific opportunities may be public safety opportunities and/or quality of life opportunities.

In an example, the three-dimensional dataset forming a model of an urban landscape may include discreet data containers associated with physical objects into which data is associated. The discrete data containers may include data containers representative of buildings. The data containers representative of buildings may be associated with municipal records and observed data.

In another embodiment, the method of identifying actionable location-specific opportunities includes receiving a two-dimensional dataset forming a map of an urban area, using heuristic algorithms to analyze municipal records to identify actionable location-specific opportunities, and creating a data compilation that identifies the actionable location-specific opportunities.

The present disclosure also provides for a data compilation illustrating actionable location-specific opportunities comprising a two-dimensional dataset forming a map of an urban area, and visual indications of actionable location-specific opportunities associated with the map, wherein the indications are derived from predictive heuristic analysis of municipal records.

The methods disclosed herein may be used to validate and benchmark inquiries from hypotheses and learning systems about potential or probable outcomes from street-level conditions.

The present disclosure also provides a system for identifying actionable location-specific opportunities, the system comprising a controller, and a memory coupled to the controller, wherein the memory is configured to store program instructions executable by the controller. In response to executing the program instructions, the controller is configured to receive a three-dimensional dataset forming a model of an urban landscape, extract objects within the urban landscape from the three-dimensional dataset, access municipal records corresponding to a location associated with the urban landscape, identify location-specific matches between the objects within the three-dimensional dataset and elements of the municipal records, apply heuristic algorithms to evaluate the location-specific matches, and create a data compilation that identifies actionable location-specific opportunities.

The elements of the municipal records used to analyze the three-dimensional dataset may include at least one of building code violations, commercial licensing, permits, arrears on taxes, liens, foreclosure history, or combinations thereof.

In an example, the data compilation is a list including visual indications of actionable location-specific opportunities. Alternatively, or in addition to, the data compilation is a map including visual indications of actionable location-specific opportunities.

The actionable location-specific opportunity may be an economic opportunity, wherein the economic opportunities may be based on a total direct economic opportunity cost measurement based on at least one of a new revenue, a new revenue plus direct cost savings, new revenue plus direct cost savings and indirect cost savings, or combinations thereof.

The actionable location-specific opportunities may be at least one of a public safety opportunity, a quality of life opportunity, or combinations thereof.

An object of the invention is to identify actionable revenue generating opportunities.

Another object of the invention is to identify location-specific “quality of life” scores and identify opportunities to improve quality of life with more beautiful and cleaner communities and to increase the overall safety.

Another advantage of the invention is to enable cost effective implementation of street level regulation.

A further advantage of the invention is that it may level the playing field for vendors and operators seeking street level licenses and permits.

Yet another advantage of the invention is to provide municipalities with an efficient eye to current street level activity with little or no capital investment.

Still another advantage of the invention is to provide streamlined processes such that municipalities can see results in weeks instead of months compared to current alternative methods.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A is a schematic of an embodiment of the system disclosed herein.

FIG. 1B is a flow chart of an embodiment of the method disclosed herein.

FIG. 2 is a schematic of an embodiment of the method disclosed herein.

FIG. 3 is a schematic of a three-dimensional dataset with corresponding elements identified by the system disclosed herein.

FIG. 4 is a schematic of an example of a data compilation in the form of a map.

FIG. 5 is a schematic of an example of a data compilation in the form of a map.

FIG. 6 is a schematic of an example of a data compilation in the form of a list.

FIG. 7 is an example of three-dimensional data acquisition.

FIG. 8 is a schematic of an embodiment of the system as disclosed herein.

### DETAILED DESCRIPTION

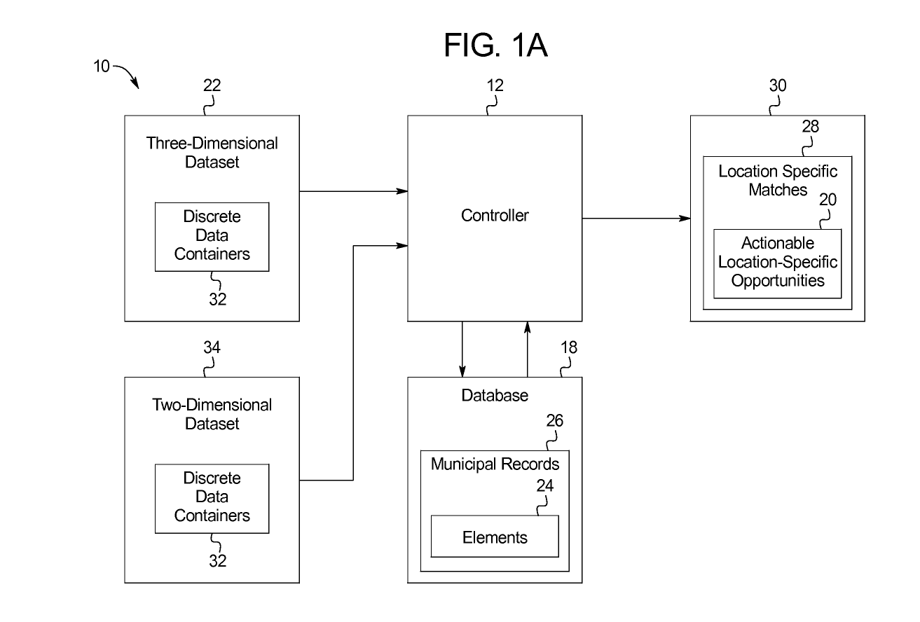

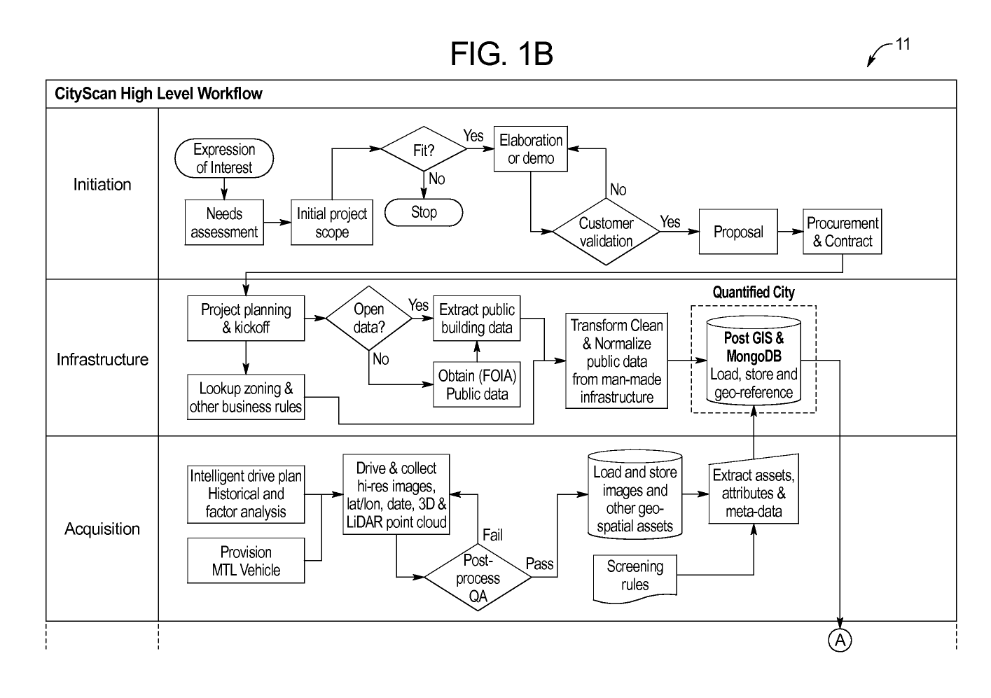

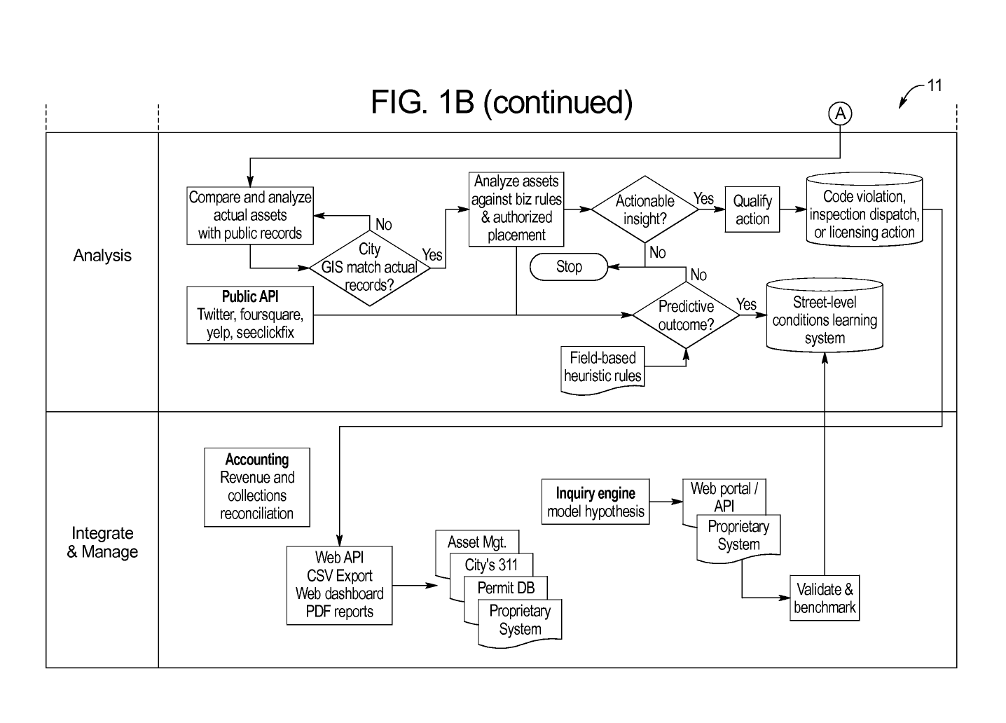

The present disclosure provides systems 10 and methods 11 in which municipal records 26 are analyzed in combination with three-dimensional (3D) datasets 22 using contextual heuristics to identify actionable location-specific opportunities 20 that are potential revenue generating opportunities for municipalities. For example, as shown in FIGS. 1A-1B, the systems 10 and methods 11 provided herein may be adapted to analyze municipal records 26 in combination with three-dimensional datasets 22 using contextual heuristics to identify location-specific opportunities 28 to improve safety, quality of life, and other factors.

In an example, the actionable location-specific opportunities 20 are economic opportunities. As discussed above, the actionable location-specific opportunities 20 may include sources of revenue for municipalities. For example, the system 10 may identify an invalid permit associated with a street sign or building, as the actionable location-specific opportunity 20, wherein the system 10 notifies the municipality of an opportunity for revenue. The economic opportunities may be based on a total direct economic opportunity cost measurement based on new revenue, new revenue plus direct cost savings, and/or new revenue plus direct cost savings and indirect cost savings. Alternatively, or in addition to, the actionable location-specific opportunities 20 may be public safety opportunities or quality of life opportunities. For example, public safety opportunities and quality of life opportunities may include a road or traffic hazard, construction zone, damaged road signs, among others.

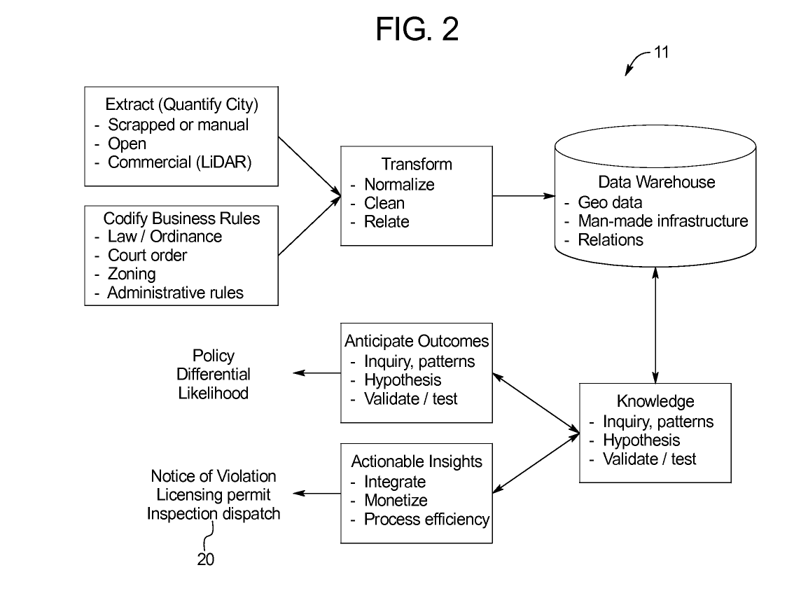

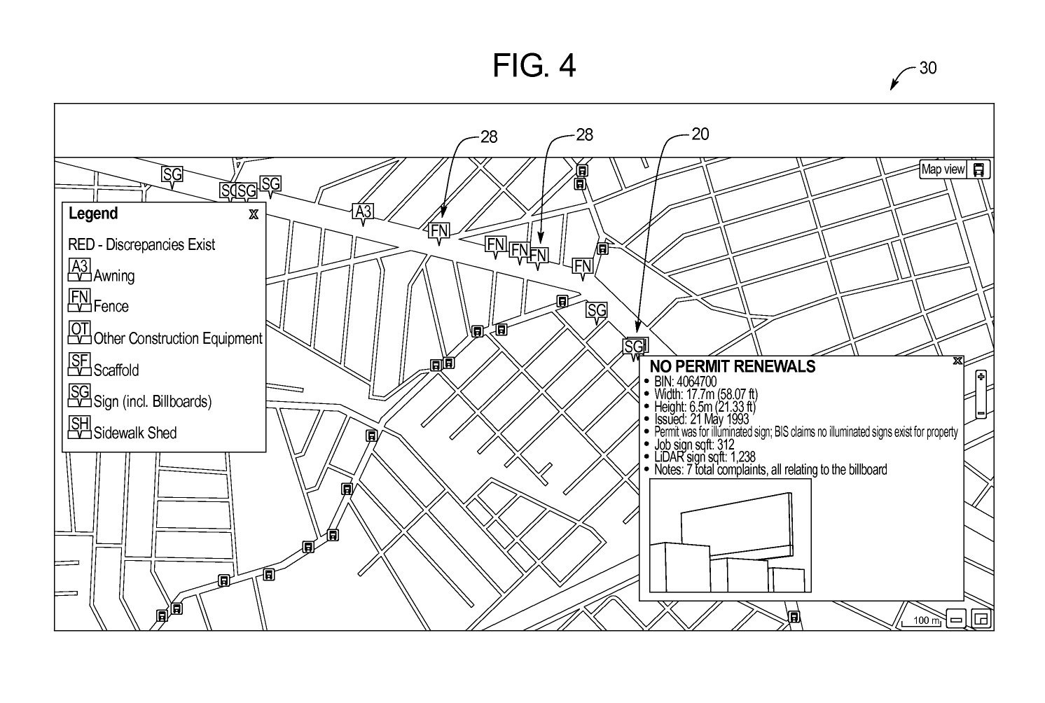

In an embodiment the system 10 and method 11 of identifying actionable location-specific opportunities 20 include receiving a three-dimensional dataset 22 forming a model of an urban landscape, as shown in FIG. 2. For example, the three-dimensional data set 22 may be acquired from scanning an urban landscape, such as the landscape in FIG. 4.

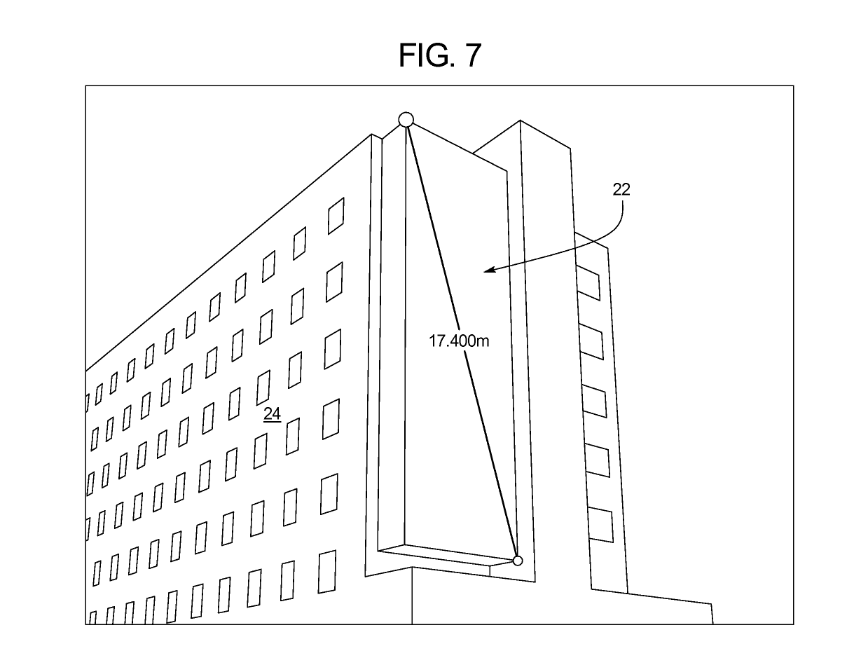

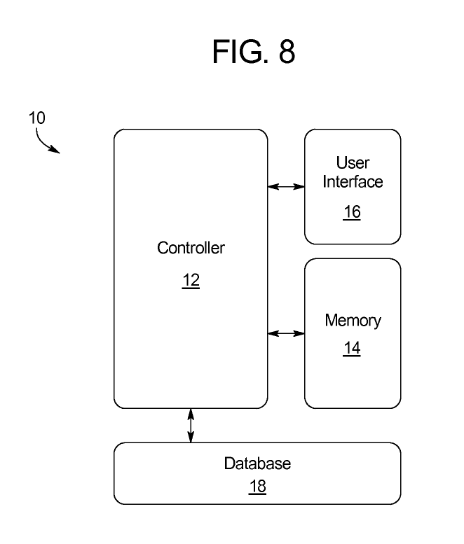

The three-dimensional dataset 22 may be acquired by incorporating the most advanced mobile terrestrial LiDAR, GPS, and imaging systems coupled with innovative rule-based extraction technology processes and analytics, to deliver advanced outdoor intelligence. FIG. 7 illustrates an example of the data acquisition of the three-dimensional dataset 22 or two-dimensional dataset 34.

The three-dimensional dataset 22 or the two-dimensional dataset 34 may be obtained by extraction, transformation, and loading data from open data portals, such as data.cityofchicago.org or nycopendata.socrata.com. If three-dimensional dataset 22 is not available via open portals, the workflow may include using computer scripts to “scrape” the data from other sources (e.g., use building BIN and address or GPS latitude/longitude centroid of the location of the building). For example, the three-dimensional dataset 22 may be transformed by developing a script to normalize fields (particularly addresses) under a well-defined taxonomy and index and load into a database 18 with geo-spatial component and geometry of man-made infrastructure (e.g. PostGIS).

The system 10 and method 11 may include cleaning the three-dimensional dataset 22, as shown in FIG. 2, (i.e., normalize the fields), particularly with respect to addresses associated with the elements 24 within the three-dimensional dataset 22. For example, the method 11 may include adding an alternate address list if the normalized address does not match the absolute address or is not within define street range using the street centerline file to interpolate a point from address (i.e. corner lot or odd/even sequence and relation to direction). The system 10 may be used to create various indexes providing relationships between man-made infrastructure, particularly buildings.

The three-dimensional dataset 22 collected may be used to create identifications of physical structures or “containers” into which acquired data is to be mapped. In an example, the three-dimensional dataset 22 forming a model of an urban landscape may include discrete data containers 32 associated with physical objects into which data is associated. The discrete data containers 32 may include data containers representative of buildings. The discrete data containers 32 representative of buildings may be associated with elements 24 of the municipal records 26, as described below.

A document-oriented database 18 may be created (e.g., using MongoDB or similar) to aggregate the three-dimensional data 22 to a “building level” without the need to crosswalk multiple foreign key relationships. With respect to this example, “building” may be a proxy for a building, a billboard, or any other physical structure onto which data may be mapped. The three-dimensional datasets 22 (e.g., data collected through LiDAR or similar) or two-dimensional dataset 34 may be extracted and transformed into building level discrete data containers 32.

Once the three-dimensional data 22 is collected, extracted, transformed, and loaded, the system 10 may be used to compare the three-dimensional data 22 and the elements 24 within municipal records 26. Specifically, the system 10 and method 11 further include analyzing the three-dimensional dataset 22 to determine location-specific matches 28 between elements 24 within municipal records 26 and the three-dimensional dataset 22. The location-specific matches 28 may be matches between the elements 24 within the municipal records 26 and the discrete data containers 32 within the three-dimensional dataset 22.

In an example, the elements 24 of the municipal records 26 used to analyze the three-dimensional dataset 22 may include building code violations. Alternatively, or in addition to, the elements 24 of the municipal records 26 used to analyze the three-dimensional dataset 22 may include commercial licensing. Similarly, the elements 24 of the municipal records 26 used to analyze the three-dimensional dataset 22 may include at least one of permits, arrears on taxes, liens, foreclosure history, or combinations thereof.

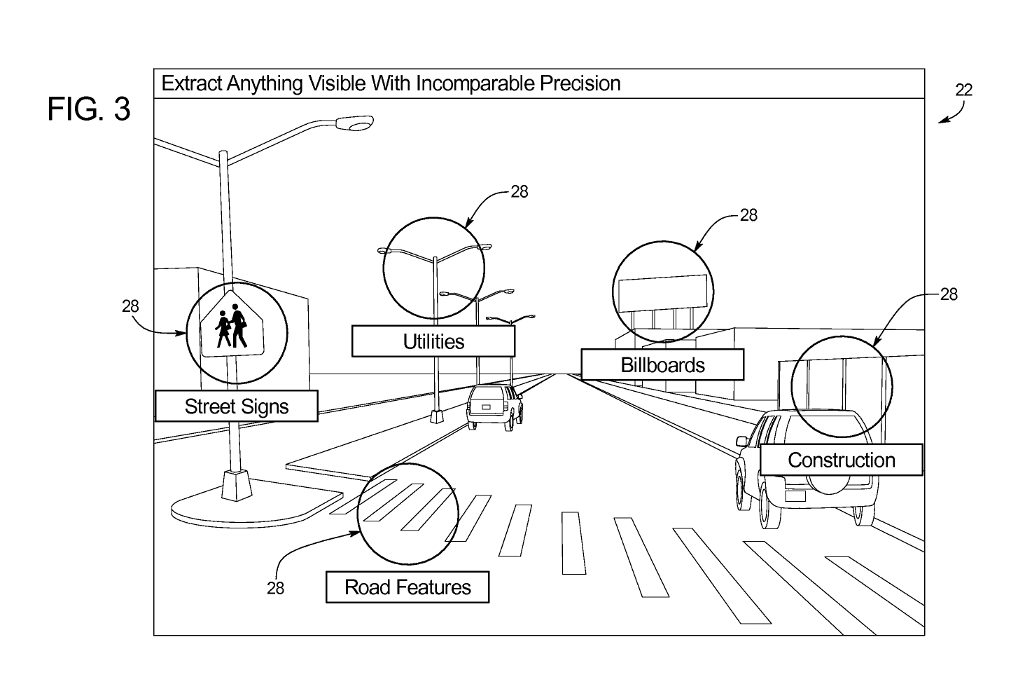

In addition, the method 11 includes using heuristic algorithms to evaluate the location-specific matches 28 to create a data compilation 30 that identifies actionable location-specific opportunities 20. For example, the system 10 compares the three-dimensional dataset 22 with the elements 24 within the municipal records 26 accessible by the system 10. In an example, the municipal records 26 may be stored in the database 18. Alternatively, the municipal records may be stored outside of the system 10, yet accessible by the system 10. The system 10 determines location-specific matches 28 between the three-dimensional data 22 and the municipal records 26. The location-specific matches 28 are included within the data compilation 30. For example, as shown in FIG. 3, examples of location-specific matches 28 within the three dimensional dataset 22 include street signs, utilities, billboards, construction, and road features.

The data compilation 30 may illustrate actionable location-specific opportunities 20 comprising a two-dimensional dataset 34 forming a map of an urban area, and visual indications of actionable location-specific opportunities 20 associated with the map, wherein the indications are derived from predictive heuristic analysis of municipal records 26. Alternatively, or in addition to, the data compilation 30 may illustrate actionable location-specific opportunities 20 comprising a three-dimensional dataset 22 forming a map of an urban area.

The heuristic algorithms may include multivariate modeling that may be implemented to produce an “expected” set of metrics. The system 10 may then be used to compare the calculated expected results with the actual finding to establish a difference (residuals). The difference between the metric values that the model “predicts” and what is actually measured should trend around zero. When the residuals trend (meaning both statistically and persistently different) to a non-zero amount, we know with a high level of certainty that behavior for that system has changed. A variety of statistical methods, data analysis, visualization, and computer programming methods may be implemented to develop predictive models to facilitate data-driven insights about the built environment. The system 10 may provide a closed-loop feedback system for improving predictions based on what is observed, predicted, and learned by the observations and predictions. For example, the system 10 may be used to identify locations within a municipality toward which efforts may be made or expenditures taken to improve the quality of life of the neighborhood. The methods 11 disclosed herein may be used to validate and benchmark inquiries from hypotheses and learning systems about potential or probable outcomes from street-level conditions.

The data compilation 30 may take any suitable form including, but not limited to, a visual map, graph, list, or other data compilation that includes indicators that highlight actionable location-specific opportunities 20 for code enforcement that impact city revenue and life safety indicators. For example, the data compilation 30 may be a map including visual indications of actionable location-specific opportunities 20. Alternatively, or in addition to, the data compilation 30 may be a list including visual indications of actionable location-specific opportunities 20. Such data compilations 30 may be interactive and/or update in real-time based on changes in the underlying data sets and/or user selections.

In one embodiment, the data compilation 30 may be expressed through a dashboard control. The dashboard control may be a map of a city with user-selectable data overlays. For example, a user may select to display economic, safety, or quality of life overlays. In each category, scores may be assigned to and displayed on specific geographic areas based on heuristic analysis of the underlying three-dimensional dataset 22 or two-dimensional dataset 34.

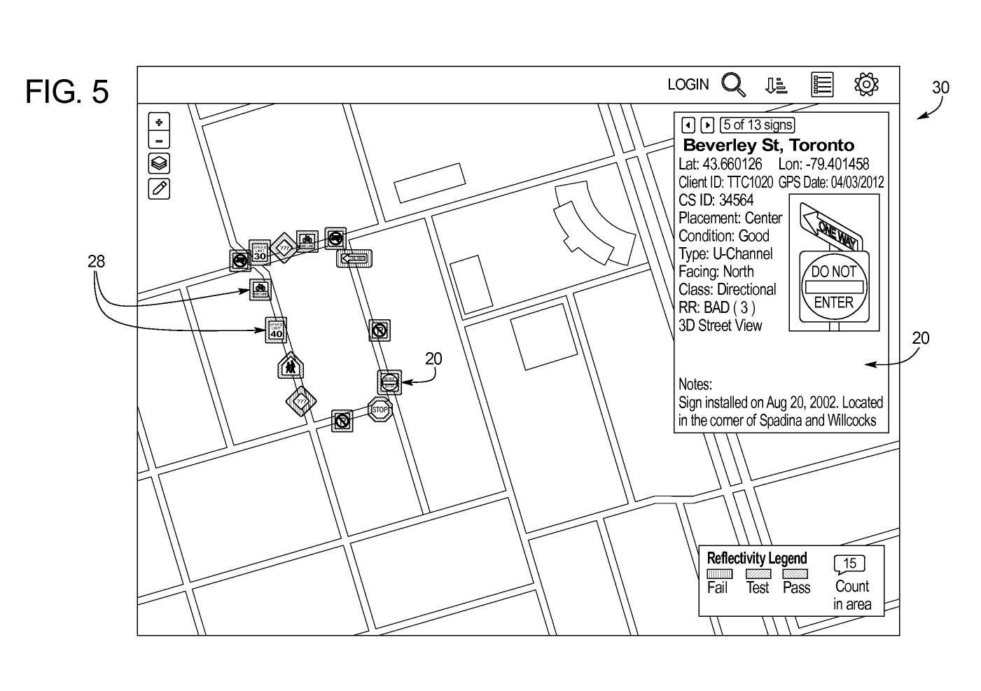

For example, as shown in FIG. 4, the data compilation 30 is a map with identified location specific matches 28 and specific actionable location-specific opportunities 20. The actionable location-specific opportunity 20 in the example in FIG. 4 corresponds to a lack of permit renewal that a municipality may collect as a result of the system 10 identifying the actionable location-specific opportunity 20. FIG. 5 illustrates another example of a data compilation 30 that identifies an actionable location-specific opportunity 20 with a “Do Not Enter” sign that is damaged. In such case, the actionable location-specific opportunity 20 is associated with public safety, rather than an economic opportunity.

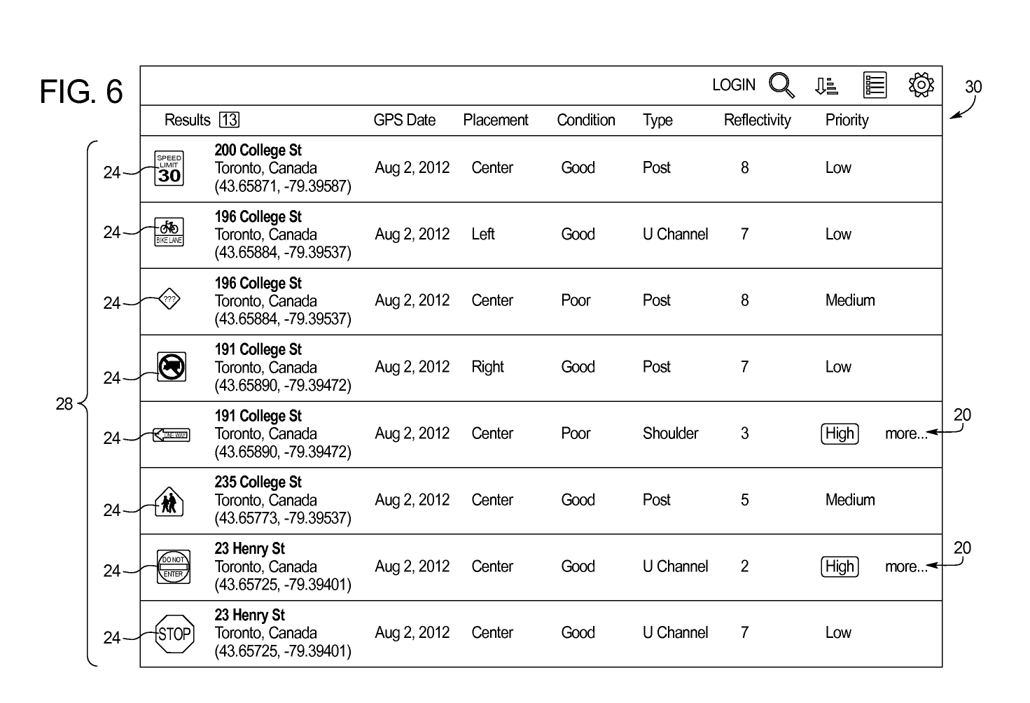

FIG. 6 demonstrates yet another example of a data compilation 30, wherein the data compilation 30 is in the form of a list of the location specific matches 28, each associated with extracted elements 24 from the three-dimensional dataset 22, wherein the elements 24 are associated with accessed municipal records 26. As shown “One Way” sign and the “Do Not Enter” sign are actionable location-specific opportunities 20 due to their low reflectivity.

The present disclosure also provides a system 10 for identifying actionable location-specific opportunities 20, the system 10 comprising a controller 12, and a memory 14 coupled to the controller 12, wherein the memory 14 is configured to store program instructions executable by the controller 12. In response to executing the program instructions, the controller 12 is configured to receive a three-dimensional dataset 22 forming a model of an urban landscape, extract elements 24 within the urban landscape from the three-dimensional dataset 22, access municipal records 26 corresponding to a location associated with the urban landscape, identify location-specific matches 28 between the elements 24 within the three-dimensional dataset 22 and elements 24 of the municipal records 26, apply heuristic algorithms to evaluate the location-specific matches 28, and create a data compilation 30 that identifies actionable location-specific opportunities 20.

In an example, particular geographical areas may be scored, wherein the score indicates the likelihood of that area to generate revenue for the city based on code enforcement. The score may be associated with the relative amount of the revenue that may be generated from that geographical area. Such areas may be visually represented by any number of visual identifiers, such as, color coded map segments or overlays, icons, numbers, among others. The creation of such a visually interactive map showing the location-specific actionable opportunities may provide a significant in methods for generating municipal revenue.

In a specific example, the systems 10 and methods 11 disclosed herein may be used to evaluate the likelihood of finding a building violation using the following process. First, buildings may be identified that have a violation description of “Contrary to Original Plan.” A building permit may be identified for the alteration or renovation prior to the violation, if one exists. The system 10 may text mine the work description field in the building permit for frequencies or patterns of keywords. Finally, for new building permits that have similar keywords, assign a score based likelihood that the renovation will result in a violation. The score may be used to map the relative value of building inspections in specific locations. Various data sets may be utilized in similar fashions, including, building permits, building violations, information calls, among others. It is important to note that this example does not rely on data collected using MTL techniques.

Using the billboard example to illustrate an example in which data collected using MTL techniques may be used to provide a map of comparative economic opportunity, the dataset collected using MTL techniques may be overlaid with city permits to identify missed revenue from non-conforming billboards. Then, using the identified missed revenues, comparative scores may be provided to identify specific locations in which revenue may be collected through enforcement of existing regulations.

In an example of safety scoring, areas that are likely to pose the greatest threat to life safety and expose the city to the most liability may be identified by their relative threat. For example, the systems 10 and methods 11 disclosed herein may be used to evaluate the likelihood of fire using the following process. First, buildings may be identified in which there is a violation description such as, “Blocked Fire Door,” “Building in Disrepair,” “Chimney,” “Fire Extinguisher Required,” or anything else relating to fires. The system 10 then assigns a relative threat score to each violation. The relative threat score may be further modified for buildings in which the exterior construction material is “Frame,” where the property is or recently was in foreclosure, or other heuristic factors that increase the likelihood of fire.

Similarly, the systems 10 and methods 11 disclosed herein may be used to build a predictive model assessing threat of fire at specific locations by using the following process. First, buildings may be identified where the violation description is “Fire Damage” (i.e., after the fact). Then, the system 10 determines the number and nature of the violations against the building prior to the fire (e.g., the description of the violation, the department to which it was assigned, etc.). Further, the system 10 may determine any previous 311 calls made related to the property prior to the fire. Lastly, the system 10 builds a predictive model based on an analysis of the data collected. The predictive model may be used to assign relative threat scores for specific locations.

In an example of quality of life scoring, areas that are likely to be impacted by situations or events that impact the quality of life of those in the area may be identified by the predicted relative impact to the quality of life. For example, sign violations can impact an area's “quality of life” rating, for example, by interfering with desired street parking rules. In a specific example, the systems 10 and methods 11 disclosed herein may be used to evaluate the likelihood of sign violations using the following process. First, an evaluation of sign violation records may show that sign violations cluster around certain days of the year. Matching this knowledge with municipal records of where there are sign restrictions enables the system to create a priority list of commercial corridors to inspect for sign violations based on the time of year.

Returning to the out-of-home marketing example, the systems 10 and methods 11 disclosed herein may be implemented to provide a comprehensive set of visualization, indexing, scoring and analytics tools to help brands and billboard operators improve their decision-making process and make smart buying decisions based on individual billboards' actual demographic reach and frequency, allowing scalable outdoor direct response campaigns while provide quick proof of performance for billboard operators.

For buyers, the systems 10 and methods 11 disclosed herein can be used to provide a billboard index and visual planner. For example, the billboard index and visual planner may include a set of video and scoring tools targeted to brands and agencies allowing them to optimize the artwork depending on the position and actual visibility of each billboard. The systems 10 and methods 11 may further be used to provide outdoor analytics tools, including smart buying tools that identify the most effective locations for the placement of new campaigns, enable direct response, and report on results to brand partners. Elements of the systems and methods may also provide innovative services for brands to engage consumers in scalable direct response marketing campaigns (e.g., customers may take a picture of the billboard for promotional incentive).

For sellers, the systems 10 and methods 11 disclosed herein can be used to provide proof of performance measures, such as verification services to drive down the existing cost of monthly surveying of each billboard for customer reporting to agencies and brands. The system 10 may also be used to provide billboard insurance, which may include a notification service to alert operators of any problems with their inventory to help them avoid fines from the municipality's enforcement efforts. The billboard index and visual planner mentioned above may help sellers best position their inventory to sell at the highest possible price given actual data and the outdoor analytics may provide a set of tools to identify and aggregate available and effective spaces for the placement of new signage across the country. In preferred embodiments, the tools provided integrate the current municipal zoning eligible for commercial signage with the global inventory of billboard leases, the combination allowing the identification of gaps or hot-zones for selling new and existing billboard locations or potential spaces for digital signage.

It will be understood by those skilled in the art that similar advantages exist across numerous scenarios, not simply for billboard enforcement and out-of-home media opportunities. For example, on-premise sign compliance, including permitting, fees, inspections, and zoning regulations, often require a fairly large amount of corresponding paperwork to assure that the sign falls within the parameters of legitimacy. An inspector is required to collect a number of data points depending on the type of sign and the business on-goings that occur within the respective locations. The present system 10 may determine if the sign associated with the business is permitted to be at the location, whether the business is licensed according to municipal regulations, whether the sign and business are legitimate and documented, whether the business or sign falls within the parameters of the local municipal zoning laws (i.e., if a store is selling tobacco products and is located within a defined distance of a school, zoning law would be violated), whether the business is required to have a special use permit (e.g., such as a tattoo parlor license), and whether the permit it current.

Utility companies partner with municipalities across the nation in an effort to maintain street-level assets, such as streetlights and utility poles, in a more cost-efficient manner than working separately. As such, utility companies, like cities, may increase efficiency if their assets are included in a comprehensive inventory that helps to prioritize maintenance and upgrade requests. The environment around these assets is also important for utility companies to inventory. For example, vegetation encroachment to the poles and the attached lines, along with the management of said vegetation, is one of the largest annual costs to utility companies. Similarly, measuring the sag of wires in between poles can help to determine their overall efficiency and provide insight as to how to best route power in heavy-use areas. The introduction of an MTL scan can help to prescribe the best possible strategy for utility companies to perform proactive, rather than reactive, maintenance strategies. For example, the system 10 may scan and record electric or utility poles as well as attached devices, vegetation encroachment to equipment and power lines, excessive power line wire sag, manhole and vaults inventory, streetlights inventory, and/or street curb identification. The system 10 may identify gaps between city license records and street level conditions.

Revenue tax collection from business licenses such as cigarette and amusement tax from retail establishments, which directly impact revenue and can support indirect health benefits on smoking cessation programs. All these are just a few examples of location-specific actionable data that may be valuable to municipalities, companies, and individuals to capitalize on opportunities. Just as present systems and methods are inefficient at identifying location-specific out-of-home marketing opportunities, the presently used systems and methods are inefficient at identifying actionable opportunities to improve public safety, quality of life, etc. Accordingly, there is a need for systems and methods for identifying location-specific actionable opportunities, as described and claimed herein.

As mentioned above and schematically shown in FIG. 9, aspects of the systems and methods described herein are controlled by one or more controllers 12. The one or more controllers 12 may be adapted to run a variety of application programs, access and store data, including accessing and storing data in the associated databases 18, and enable one or more interactions as described herein. Typically, the controller 12 is implemented by one or more programmable data processing devices. The hardware elements, operating systems, and programming languages of such devices are conventional in nature, and it is presumed that those skilled in the art are adequately familiar therewith.

For example, the one or more controllers 12 may be a PC based implementation of a central control processing system utilizing a central processing unit (CPU), memory 14 and an interconnect bus. The CPU may contain a single microprocessor, or it may contain a plurality of microprocessors for configuring the CPU as a multi-processor system. The memory 14 may include a main memory, such as a dynamic random access memory (DRAM) and cache, as well as a read only memory, such as a PROM, EPROM, FLASH-EPROM, or the like. The system may also include any form of volatile or non-volatile memory 14. In operation, the memory 14 stores at least portions of instructions for execution by the CPU and data for processing in accord with the executed instructions.

The one or more controllers 12 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 12 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces 16 for the controller 12. For example, the one or more controllers 12 may include a graphics subsystem to drive the output mechanism. The links of the peripherals to the system may be wired connections or use wireless communications.

Although summarized above as a PC-type implementation, those skilled in the art will recognize that the one or more controllers 12 also encompasses systems such as host computers, servers, workstations, network terminals, and the like. Further one or more controllers 12 may be embodied in a device, such as a mobile electronic device, like a smartphone or tablet computer. In fact, the use of the term controller 12 is intended to represent a broad category of components that are well known in the art.

Hence aspects of the systems and methods provided herein encompass hardware and software for controlling the relevant functions. Software may take the form of code or executable instructions for causing a controller 12 or other programmable equipment to perform the relevant steps, where the code or instructions are carried by or otherwise embodied in a medium readable by the controller 12 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 14 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method and portable electronic device may be provided based on various combinations of the features and functions from the subject matter provided herein.

What is claimed is:

1. A method of identifying actionable location-specific opportunities comprising the steps of:
receiving a three-dimensional dataset forming a model of an urban landscape;
analyzing the three-dimensional dataset and elements of municipal records to identify location-specific matches between the three-dimensional dataset and elements of the municipal records; and
using heuristic algorithms to evaluate the location-specific matches to create a data compilation that identifies one or more actionable location-specific opportunities.

2. The method of claim 1 wherein the elements of the municipal records used to analyze the three-dimensional dataset include building code violations.

3. The method of claim 1 wherein the elements of the municipal records used to analyze the three-dimensional dataset include at least one of commercial licensing, permits, arrears on taxes, liens, foreclosure history, or combinations thereof.

4. The method of claim 1 wherein the data compilation is a map including visual indications of actionable location-specific opportunities.

5. The method of claim 1 wherein the data compilation is a list including visual indications of actionable location-specific opportunities.

6. The method of claim 1 wherein the actionable location-specific opportunities are economic opportunities.

7. The method of claim 10 wherein the economic opportunities are based on a total direct economic opportunity cost measurement based on new revenue.

8. The method of claim 10 wherein the economic opportunities are based on a total direct economic opportunity cost measurement based on new revenue plus direct cost savings.

9. The method of claim 10 wherein the economic opportunities are based on a total direct economic opportunity cost measurement based on new revenue plus direct cost savings and indirect cost savings.

10. The method of claim 1 wherein the actionable location-specific opportunities are at least one of a public safety opportunity, a quality of life opportunity, or combinations thereof.

11. The method of claim 1 wherein the three-dimensional dataset forming a model of an urban landscape includes discreet data containers associated with physical objects into which data is associated.

12. The method of claim 11, wherein the discrete data containers include data containers representative of buildings.

13. The method of claim 12 wherein data containers representative of buildings are associated with municipal records and observed data.

14. A data compilation illustrating actionable location-specific opportunities comprising:
a two-dimensional dataset forming a map of an urban area; and
visual indications of actionable location-specific opportunities associated with the map, wherein the indications are derived from predictive heuristic analysis of municipal records.

15. A system for identifying actionable location-specific opportunities, the system comprising:
a controller;
a memory coupled to the controller, wherein the memory is configured to store program instructions executable by the controller;
wherein in response to executing the program instructions, the controller is configured to:
receive a three-dimensional dataset forming a model of an urban landscape;
access municipal records corresponding to a location associated with the urban landscape, wherein the municipal records include elements;
identify location-specific matches between the three-dimensional dataset and elements of the municipal records;
apply heuristic algorithms to evaluate the location-specific matches; and
create a data compilation that identifies actionable location-specific opportunities.

16. The system of claim 15 wherein the elements of the municipal records used to analyze the three-dimensional dataset include at least one of building code violations, commercial licensing, permits, arrears on taxes, liens, foreclosure history, or combinations thereof.

17. The system of claim 15 wherein the data compilation is a list, map, or both, wherein the data compilation includes visual indications of actionable location-specific opportunities.

18. The system of claim 15 wherein the three-dimensional dataset forming a model of an urban landscape includes discreet data containers associated with physical objects into which data is associated.

19. The system of claim 15 wherein the actionable location-specific opportunity is an economic opportunity, wherein the economic opportunities are based on a total direct economic opportunity cost measurement based on at least one of a new revenue, a new revenue plus direct cost savings, new revenue plus direct cost savings and indirect cost savings, or combinations thereof.

20. The system of claim 15 wherein the actionable location-specific opportunities are at least one of a public safety opportunity, a quality of life opportunity, or combinations thereof.
